(19) United States
(12) Patent Application Publication
(10) Pub. No.: US 2003/0127549 A1
(43) Pub. Date: Jul. 10, 2003

(54) Multi-sided shaft for a crusher

(76) Inventors: Chris Greisedieck, St. Louis, MO (US); Steve Rogan, St. Louis, MO (US)

Correspondence Address: Paul M. Denk, 763 S. New Ballas Road, St. Louis, MO, 63141, US

(21) Appl. No.: 10/365,746

(22) Filed: Feb. 14, 2003

Related U.S. Application Data
(63) Continuation-in-part of application No. 10/120,709, filed on Apr. 11, 2002.
(60) Provisional application No. 60/284,096, filed on Apr. 17, 2001.

(51) Int. Cl. B02C 13/00

(52) U.S. Cl. 241/194

(57) ABSTRACT

A shredder, crusher, hammermill, ringmill or the like is provided with a multi-sided rotor shaft to which spider arms and hammers are mounted. The rotor shaft has at least one pair, and preferably two or more pairs, of opposing sides. The hammers are pivotally mounted between supports in the shape of spiders or discs. The supports include openings which have straight sides corresponding to the number of straight sides on the rotor shaft. The straight sides of the support openings engage the rotor shaft straight sides. Hence, the supports are rotationally fixed in place relative to the rotor shaft without the use of keys and keyways, pins, bolts, or other types of fasteners, allowing for easier assembly and reduced maintenance costs for the crusher.

### CROSS-REFERENCE TO RELATED APPLICATIONS

This application is a continuation-in-part of application Ser. No. 10/120,709 entitled Multi-Sided Shaft For A Crusher filed Apr. 11, 2002, which in turn, claims benefit of provisional application Ser. No. 60/284,096 filed Apr. 17, 2001.

### STATEMENT REGARDING FEDERALLY SPONSORED RESEARCH OR DEVELOPMENT

Not Applicable.

### BACKGROUND OF THE INVENTION

This invention relates to crushers, such as shredders, hammermills and ringmills used to process ferrous and non-ferrous scrap material, and, in particular, to an improved rotor shaft for use with the crusher/shredder.

Crushers, shredders, hammermills, ringmills, and the like, are often used to process scrap material and stone, to crush or reduce the size of the material so that it can more easily be handled by other equipment for further processing or use.

Such crushers typically include a plurality of hammers or rings mounted about a rotatable shaft. As the shaft rotates, the hammers or rings engage and crush whatever media is introduced into the crusher. The hammers or rings can be mounted between supports in the form of spiders or center discs which are positionally fixed relative to the rotor shaft. Typically, the rotor shaft is cylindrical. The use of a cylindrical shaft requires that the supports be positively keyed to the shaft, for example, using a square or rectangular key on the support and a corresponding keyway on the shaft, so that the support cannot rotate relative to the shaft. The use of a keyway weakens the main shaft and makes removal of the supports and end discs a much more difficult task. Further, the key will weaken over time, and eventually the rotor assembly will shift between the shredder housings. Obviously, this can necessitate a repair of the crusher/shredder, requiring that operation of the crusher/shredder be stopped for the duration of the repair. Depending on the location of the support which is no longer positively fixed with respect to the shaft, the crusher/shredder can be shut down for a considerable period of time.

### BRIEF SUMMARY OF THE INVENTION

A shredder, crusher, hammermill, ringmill or the like is provided with a multi-sided rotor shaft to which spider arms and hammers are mounted. The rotor shaft has at least at least one pair, and preferably two or more pairs, of opposing sides. The hammers or rings are pivotally mounted between supports, which take the form of spider arms and center discs. The supports have central openings which have straight sides corresponding to the number of straight sides on the rotor shaft. The straight sides engage the rotor shaft straight sides. Hence, the supports are rotationally fixed in place relative to the rotor shaft without the use of a central key, or other types of fasteners, allowing for easier assembly and reduced maintenance costs for the shredder/shredder.

### BRIEF DESCRIPTION OF THE SEVERAL VIEWS OF THE DRAWINGS

FIG. 1 is a cross-sectional view of a crusher having a shaft of the present invention taken along line 1-1 of FIG. 2;

FIG. 2 is a cross-sectional view of the crusher taken along line 2-2 of FIG. 1;

FIG. 3 is a side elevational view of the shaft;

FIG. 4 is a cross-sectional view of the shaft taken along line 4-4 of FIG. 3;

FIG. 5 is a plan view of a support in the form of a spider which is mounted on the shaft to support hammers in the crusher/shredder;

FIG. 6 is a side elevational view of an alternate embodiment of the shaft;

FIG. 7 is a cross-sectional view of the shaft taken along line 7-7 of FIG. 6;

FIG. 8 is a plan view of a support in the form of a center disc which is mountable on the shaft to support hammers in the crusher/shredder; and

FIG. 9 is a cross sectional view of the crusher modified with respect to the use of the draw bar holds to secure the rotors in place.

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes what I presently believe is the best mode of carrying out the invention.

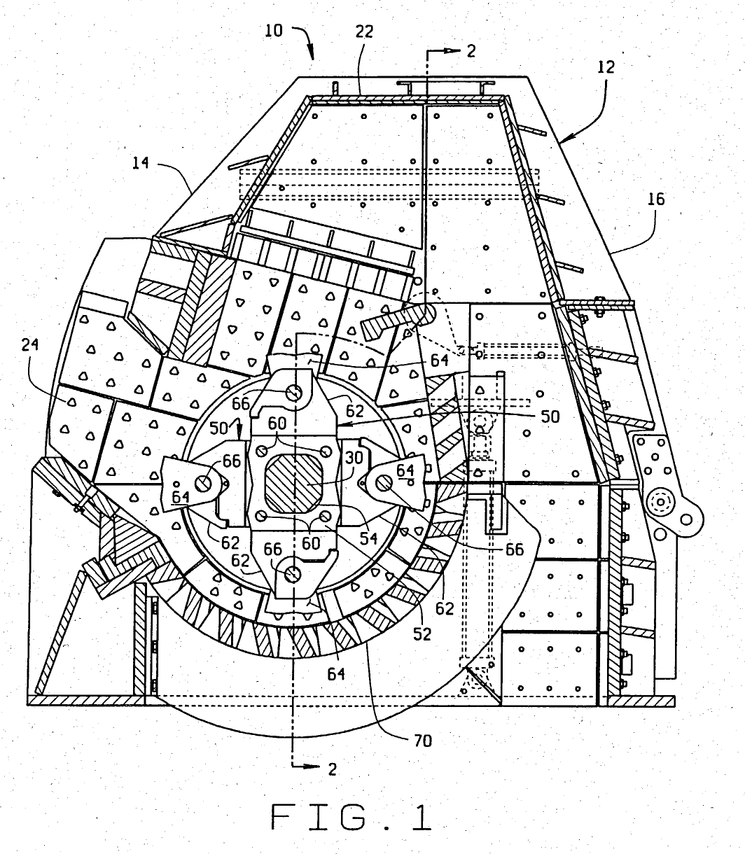

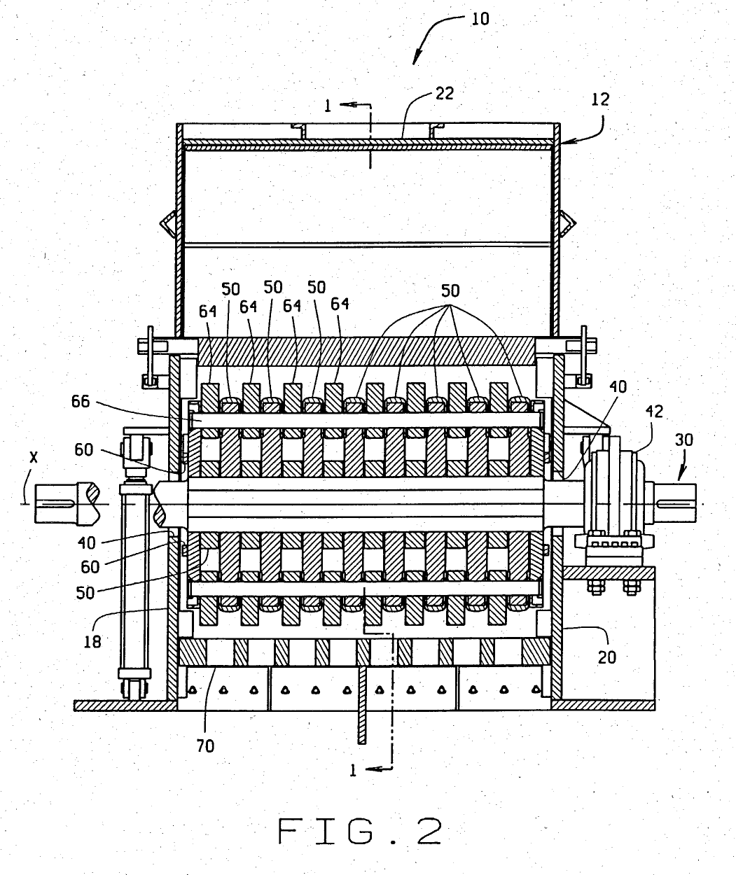

A crusher 10 is shown generally in FIGS. 1 and 2. The crusher 10 includes a housing 12 having a front wall 14, a back wall 16, side walls 18 and 20, and a top 22. A feed inlet 24 is formed in the front wall. The feed inlet 24 can extend only a portion of the side-to-side width of the crusher 10, or can extend substantially the full side-to-side width of the crusher 10.

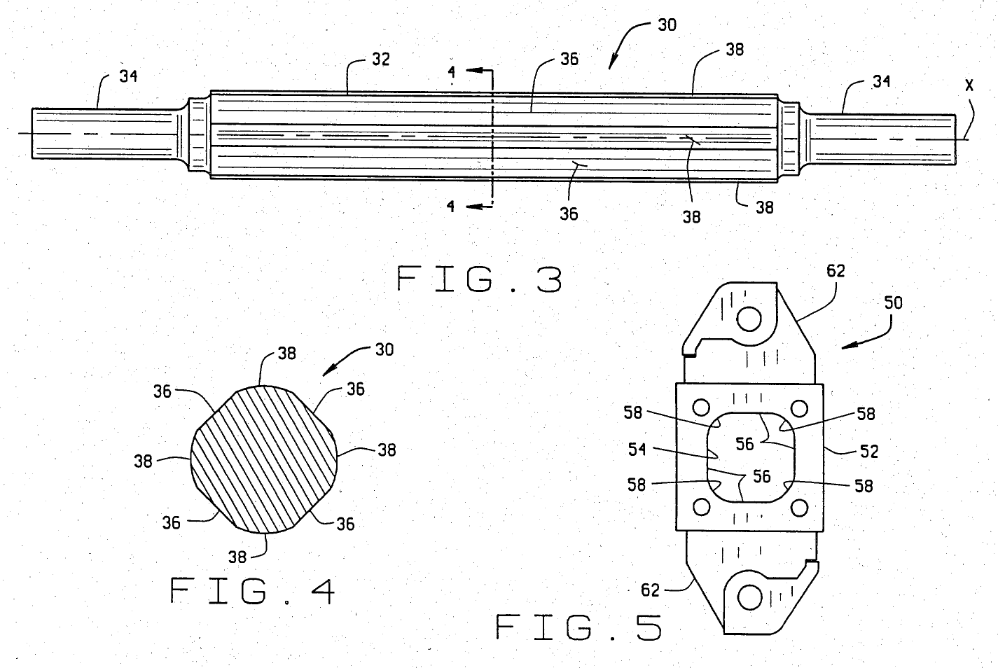

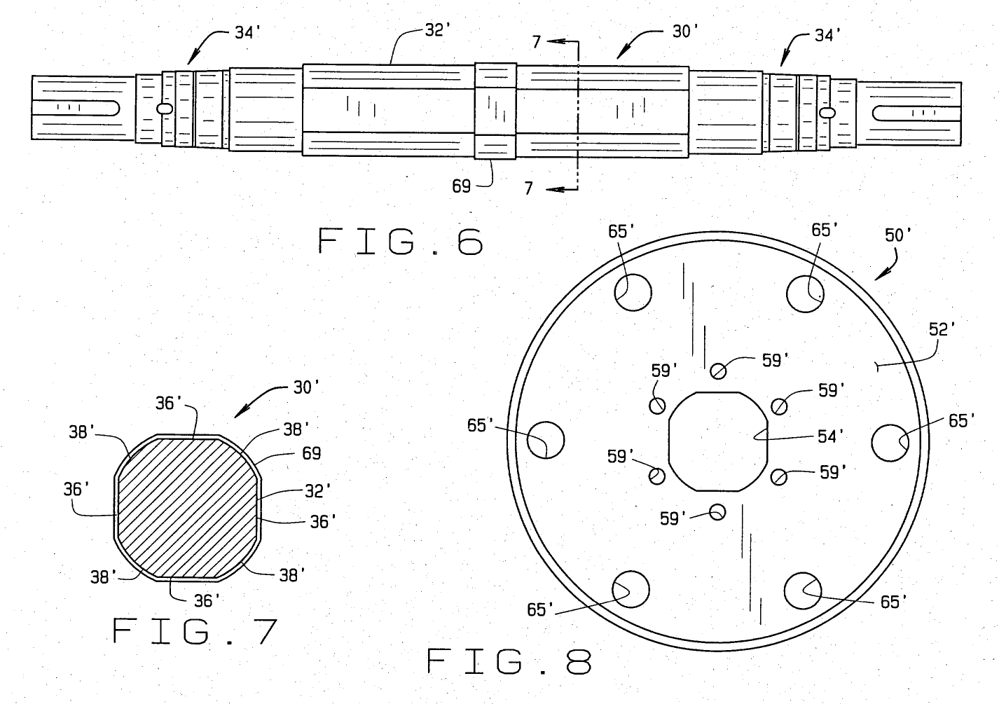

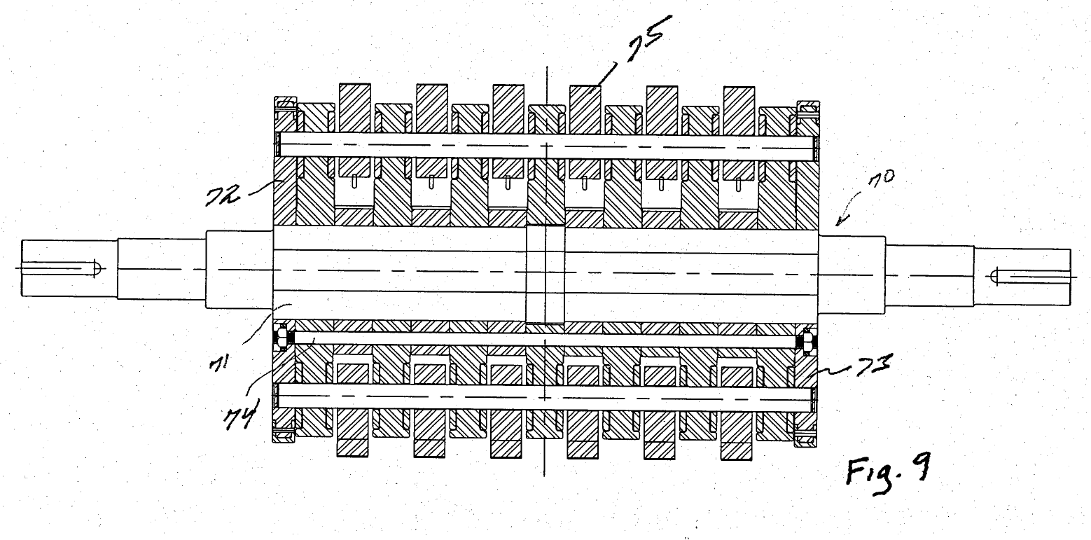

A rotor or shaft 30 extends between the side walls 18 and 20 to rotate within the housing. As seen in FIGS. 3 and 4, the rotor 30 includes a multi-sided central section 32 and two cylindrical end sections 34 extending from opposite sides of the central section. The central section 32 has eight sides, however, it could be formed with fewer sides or more sides, as desired. The central section 32 as shown in FIG. 4 includes four long sides 36 which are angled generally 90° to each other and four short sides 38 positioned between the long sides 36, and which are also angled generally 90° to each other. The short sides 38 are curved and define arcs of a circle. Thus, in cross-section, the rotor central section 32 can be defined as a circle which is flattened along four sides to form the long sides 36. Alternatively, the central section 32 can be defined as a square in which the corners are truncated or beveled; the beveled or truncated sections forming the curved short sides 38. The ends 34 of the rotor 30 extend through openings 40 in the side walls 18 and 20. At least one end of the rotor 30 is in a bearing assembly 42, to allow the rotor to rotate within the housing 12. The other end 34 of the rotor 30 can be operatively connected to, and supported by, a drive, such as a motor to rotate the shaft along its axis X.

A plurality of supports 50 are positioned on the rotor central section 32. The supports, which, illustratively, are in the form of spiders, have a generally square base 52 having with a central opening 54. The opening 54 is a generally square opening having straight sides 56 and curved, rather than sharp, corners 58. The square opening 54 of the spider support is sized to fit over the rotor central section, such that the central section long sides 34 are adjacent the straight sides of the square opening 54. Rods 60 (FIG. 2) extend transversely through openings in the bases 52 to hold the spiders 50 together on the rotor 30. A pair of arms or mounts 62 extend from opposite sides of each spider base. The arms 62 of adjacent spiders alternate, such that one set is vertical, the next is horizontal, the next is vertical, etc. Hammers or rings 64 are mounted between adjacent spiders which extend in the same direction. A hammer shaft 66 (FIG. 2) extends through the arms 62, and the hammers/rings 64 are journaled on the shafts 66. As can be appreciated, the hammers/rings are positioned at intervals of 90° around the circumference of the rotor shaft 30. The rotor shaft could be provided with more than two pair of opposing straight sides to reduce the interval between the hammers/rings. For example, if the rotor shaft had three pair of opposing straight sides, the hammers/rings could be spaced at intervals of 60° around the shaft. Four pair of opposing straight sides would allow for intervals of 45° between the hammers/rings. Alternatively, the rotor shaft could be formed with only one pair of opposing straight sides, such that the hammers/rings are positioned 180° apart from each other. This would require the use of spacers between the rings/spider arm bases.

In FIG. 8, an alternative embodiment of the support is shown. The support 50′ is shown in the form of a center disc having a plate 52′ with a central opening 54′. The central opening 54′ is substantially identical in shape to the opening 54 of the spider 50 (FIG. 5). The disc 50′ includes inner openings 59′ through which the rod 60 extends. Six openings 59′ are shown, however, more or fewer openings could be provided to accommodate more or fewer rods. The disc 50′ also includes outer openings 65′ which are evenly spaced about the disk 50′ near the periphery of the disc. The openings 65′ are sized to receive the shaft 66 upon which the hammers/rings are mounted between adjacent discs 50. Six openings 65′ are shown. More or fewer openings 65′ could be provided to accommodate more or fewer hammers/rings.

An alternate shaft or rotor 30′ is shown in FIGS. 6 and 7. As seen in FIGS. 6 and 7, the rotor 30′ includes a multi-sided central section 32′ and two cylindrical, stepped end sections 34′ extending from opposite sides of the central section. The central section 32′, at the approximate center of the rotor 30′, includes a raised hub 69 which has the same shape as the center section 32′. As seen in FIG. 7, the central section 32′ has eight sides, however, it could be formed with fewer sides or more sides, as desired. The central section 32′ as shown in FIG. 7 includes four straight sides 36′ which are angled generally 90° to each other and four curved sides 38′ positioned between the straight sides 36′, and which are also angled generally 90° to each other. The curved sides 38′ define arcs of a circle. Thus, in cross-section, the rotor central section 32′ can be defined as a circle which is flattened along four sides to form the straight sides 36′. Alternatively, the central section 32′ can be defined as a square in which the corners are truncated or beveled; the beveled or truncated sections forming the curved sides 38′. The ends 34′ of the rotor 30′ extend through openings 40 in the side walls 18 and 20.

The provision of the hub 69 allows for the supports (i.e., the center discs 50′ or the spiders 50) to be fixed to the shaft 30′ without the use of outer lock nuts to secure or tighten the rotor together. As can be seen at FIG. 9, shaft 70 incorporates its raised center portion 71, and includes a pair of cross bar holds, as at 72 and 73, held by the fasteners 74, to secure the hammers 75 thereon. This holds the entire rotor assembly to the shown shaft. A grate 70 (FIGS. 1 and 2) extends from the bottom of the inlet 24 beneath and around the rotor 30 and hammers/rings 64 in a generally arcuate fashion. The grate 70, as can be appreciated, will hold matter to be crushed in the housing to be impacted and crushed by the hammers/rings. As the material is crushed to a desired size, it will fall through the grate 70.

The use of the multi-sided rotor shaft 30, 30′ facilitates assembly of the supports 50, 50′ and hammers 64 to the rotor 30, as well as operation of the crusher 10. Because the shaft 30, 30′ includes the flat sides 36, 36′, and the support central openings 54, 54′ have the corresponding flat sides, the supports cannot rotate relative to the rotor shaft. Thus, the crusher 10 does not require keys and keyways, pins, bolts, or other fasteners to rotationally fix the supports to the rotor shaft central section 32. Additionally, the corresponding shape of the rotor shaft central section 32 to the support central opening 54, 54′ causes the rotor shaft 30 to positively drive the spiders or center discs, and hence the hammers or rings. Again, because there are no keys and keyways, pin, bolts or other fasteners which secure the spiders to the rotor shaft, there are no keys and keyways, pins, bolts, or fasteners which might sheer during operation. Hence, the use of the multi-sided rotor shaft 30, 30′, with the supports having central openings corresponding in shape to the cross-sectional shape of the rotor reduces not only the construction costs of the crusher or mill 10, but also reduces maintenance costs of the crusher or mill 10.

As various changes could be made in the above constructions without departing from the scope of the invention, it is intended that all matter contained in the above description or shown in the accompanying drawings shall be interpreted as illustrative and not in a limiting sense. For example, although the rotor 30,30′ and the support central opening 54, 54′ are both shown to have at least two flat sides, both could be provided with a single flat side. This single flat side would still allow for the support to be rotationally fixed to the shaft or rotor without the use of keys, pins, etc. This example is merely illustrative.

We claim:

1. A shaft for use with crusher machinery in the category of a shredder, crusher, hammer mill or ring mill, said machinery having a housing with a shaft support structure for holding the shaft in position for rotation therein, said shaft being multi-sided, and capable of holding at least a pair of spaced apart supports thereon, for use for holding hammers or rings applied during operations of such crusher machinery; said machinery including a hammer shaft which passes through said hammer/ring being pivotally mounted to said hammer shaft between said pair of supports.

2. The machinery of claim 1 wherein a plurality of supports capable of mounting onto the multi-sided shaft, each support pair supporting at least a pair of hammers or rings for use in the operations of the crusher machinery.

3. The machinery of claim 1 wherein the supports are in the form of spiders and/or discs.

4. The machinery of claim 2 wherein each support has an opening provided approximately centrally therethrough, and which opening has a configuration substantially similar to but slightly larger than the cross-sectional shape of the multi-sided shaft for the crusher machinery.

5. The machinery of claim 2 wherein the multi-sided shaft has at least one substantially flattened side.

6. The machinery of claim 5 wherein the multi-sided shaft has at least a pair of substantially flattened sides, with intervening curved portions provided between the relatively flat sides of the multi-sided shaft.

7. The machinery of claim 5, wherein said multi-sided shaft as four equally spaced substantially flattened surfaces integrally formed upon its shaft.

8. The machinery of claim 5 and including integral extensions projecting from either end of the multi-sided shaft, said extensions being circular in configuration, and provided for mounting the multi-sided shaft within the shaft support structure of the machinery.

9. The machinery of claim 1 including a series of rods extending transversely through the supports, to hold said supports together during rotation of the multi-sided shaft and hammers or rings of the crusher machinery.

10. The mechanism of claim 9 wherein the support includes opposed extending arms, and a hammer or ring being pivotally mounted to each arm of the said support.

11. The machinery of claim 1 and including an arcuate grate provided beneath the multi-sided shaft and its mounted supports and hammers or rings, said grate provided for holding the material to be crushed in the housing when impacted during usage of the crusher machinery.

12. The machinery of claim 2 wherein the multi-sided shaft includes a raised hub;
said hub being configured to enable said supports to be fixed to said shaft without the use of locknuts.

13. The machinery of claim 12 wherein said raised hub is generally centered relative to said multi-sided shaft.

14. The machinery of claim 9 and including draw bar holds cooperating with fastening means for holding the hammers upon the arranged shaft.
